(19) United States
(12) Patent Application Publication
(10) Pub. No.: US 2018/0191402 A1
(43) Pub. Date: Jul. 5, 2018

(54) Methods For Powering NDT Probes

(71) Applicant: Mark Anthony Novosad, Porter, TX (US)

(72) Inventor: Mark Anthony Novosad, Porter, TX (US)

(21) Appl. No.: 15/908,199

(22) Filed: Feb. 28, 2018

Related U.S. Application Data
(63) Continuation of application No. 14/531,059, filed on Nov. 3, 2014, now abandoned.
(60) Provisional application No. 61/898,747, filed on Nov. 1, 2013.

(51) Int. Cl. H04B 3/54; G01N 29/22; G01N 29/24; G01N 29/04

(52) U.S. Cl. CPC H04B 3/548; G01N 29/22; G01N 29/24; G01N 2291/0289; G01N 2291/023; G01N 29/043

(57) ABSTRACT

The present invention provides methods for powering non-destructive (NDT) probes, such as ultrasonic probes. Methods allow for power and signal transmission to NDT probes via a single wire. Methods provide for one or more bias tees disposed at ends of the single wire for power and signal transmission.

### FIELD

The present invention relates generally to methods of constructing probes used for inspecting piping and tubing and for powering such devices for both commercial and residential use, and in a particular though non-limiting embodiment, to a method of constructing ultrasonic probes and/or improving such probes already in production using bias tees.

### BACKGROUND

Presently known powering for devices, such as ultrasonic probes, typically have separate wires or cables, generally (though not always) disposed within a common coaxial housing, used to transfer power to a motor and/or additional components disposed at or near the probe head. In such configuration, power and signal transmission require separate wires. The use of separate wires for power and signal transmission during the inspection process adds additional cost to the construction of cables required to carry the signal and power to the probe, and causes configuration issues resulting from the use of separate wires such as entanglements and pinched wires.

Versions having cables containing multi-wires are, relatively speaking, very costly, increasing the cost of the probe construction. Furthermore, typical constructions are not small enough to be used in certain restrictive areas of non-destructive testing (“NDT”). Finally, there has never been a configuration that overcomes the disadvantages to the prior art for powering such key electrical equipment as, e.g., an electric turbine.

Accordingly, the present disclosure satisfies a long-felt but unmet need to provide an adequate method for powering probes and reducing the amount of cabling required for such devices.

### SUMMARY

In an exemplary embodiment of the present invention, a method of powering a non-destructive (NDT) probe is provided, including: providing power and signal transmission to the NDT probe via a single wire and disposing a first bias tee at one end of the single wire. The first bias tee has a low frequency port configured to set DC bias, a high frequency port configured to pass the signal transmission, and a combined port. The combined port is connected to the NDT probe. The combined port may conduct and transmit both the DC bias and the signal transmission. The signal transmission may use a radio frequency signal. The NDT probe may be an ultrasonic probe. The method may include a second bias tee disposed as a second end of the single wire. The first and second bias tees may be attached to opposing ends of the single wire in cabling of an existing NDT probe. The single wire may be a coaxial wire.

### DESCRIPTION OF DRAWINGS

FIG. 1 is a representation of a bias tee according to an exemplary embodiment of the present invention.

FIG. 2 is an electric turbine having a single wire for power and RF transmission with a bias tee disposed at an end of the single wire according to an exemplary embodiment of the present invention.

### DETAILED DESCRIPTION

The present invention provides a method of powering NDT provides with a single wire for both signal transmission and power supply. Embodiments of the present invention include one or more bias tees as a diplexer to set DC bias and pass radio frequency signals. Embodiments of the present invention allow for the construction of new probes with bias tees. Embodiments of the present invention reduce the costs of probe construction and reduce the cabling requirements for probe use. Embodiments of the present invention improve the performance of NDT probes by reducing wiring needs, which can limit access of the NDT probes when in use. Embodiments of the present invention provide methods of improving existing cabling of probes with a bias tee at both ends to provide power and signal transmission.

In embodiments of the present invention, the use of bias tees admits to a more cost-effective method of improving cabling already in production that is constructed having only a single coaxial core in the center. One example configuration of the invention disclosed herein would be using a single coaxial cable and attaching a bias tee at both ends in order to power electric turbines more safely, efficiently and cost-effectively.

In another example embodiment, bias tees are used to power ultrasonic/NDT probes. This configuration is favorable over other known methods because it will admit to smaller cabling assemblies, and allow the electronics to be powered through the coaxial cable with improved spatial accommodation.

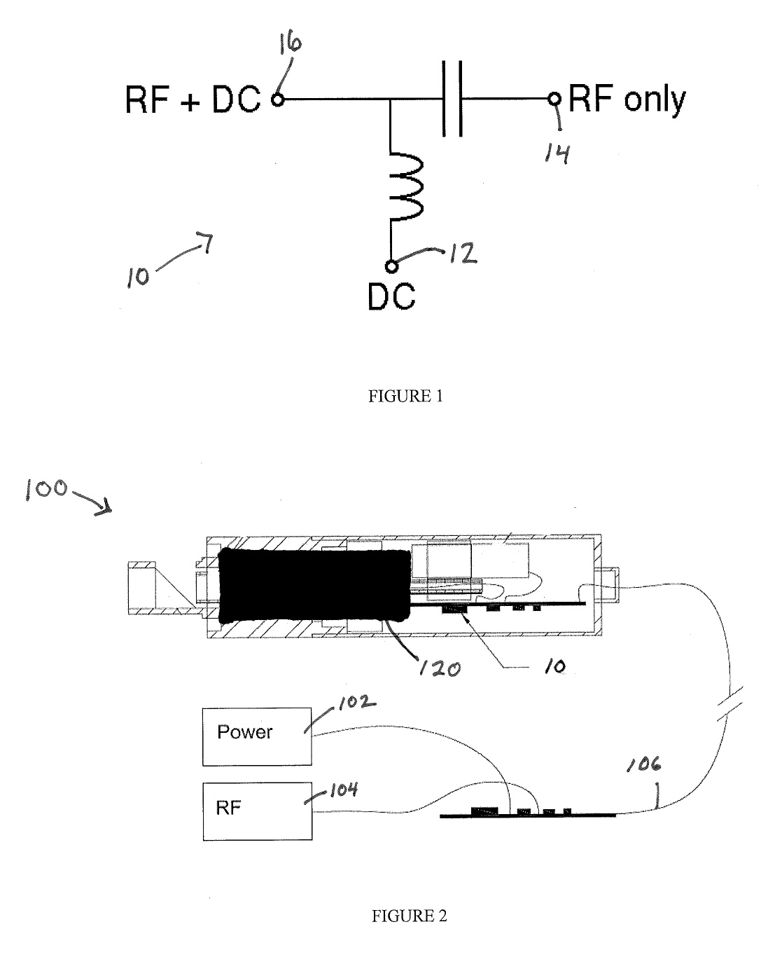

As seen in FIG. 1, bias tee 10 is essentially a three port network used for setting a DC bias point of some electronic components without disturbing other components. The bias tee 10 is a diplexer. In one embodiment, a low frequency port 12 is used to set the bias; the high frequency port 14 is then used to pass radio frequency signals while blocking the biasing levels; and the combined port 16 connects to the device, which in turn conducts and transmits both the bias signal and the radio frequency signal.

An example embodiment applying the present invention to system 100 with an electric turbine 120 is depicted in FIG. 2, in which bias tee 10 is used to insert DC power 102 into a radio frequency signal 104 and transmitted via line 106 in order to power remote devices. In one embodiment, the bias tee 10 is positioned at the receiving end of the coaxial cable so as to pass DC power from an external source to the coaxial cable running to the powered device.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

What is claimed is:

1. A method of powering a non-destructive (NDT) probe, comprising:
providing power and signal transmission to the NDT probe via a single wire;
disposing a first bias tee at one end of the single wire;
wherein the first bias tee has a low frequency port configured to set DC bias, a high frequency port configured to pass the signal transmission, and a combined port; and
wherein the combined port is connected to the NDT probe.

2. The method of claim 1, wherein the combined port conducts and transmits both the DC bias and the signal transmission.

3. The method of claim 1, wherein the signal transmission uses a radio frequency signal.

4. The method of claim 1, wherein the NDT probe is an ultrasonic probe.

5. The method of claim 1, further comprising a second bias tee disposed as a second end of the single wire.

6. The method of claim 5, wherein the first and second bias tees are attached to opposing ends of the single wire in cabling of an existing NDT probe.

7. The method of claim 1, wherein the single wire is a coaxial wire.
